(19) United States
(12) Patent Application Publication
(10) Pub. No.: US 2012/0198679 A1
(43) Pub. Date: Aug. 9, 2012

(54) Method and device for transverse slat feeding, multi-slat stringing, stringed slat piling and slat assembly spacing for manufacturing of window blind

(76) Inventors: Hsueh Tsung Chen, Taipei (TW); Chin Fu Chen, Taichung City (TW)

(21) Appl. No.: 13/023,708

(22) Filed: Feb. 9, 2011

(51) Int. Cl. B23P 11/00; B23P 19/00

(52) U.S. Cl. 29/428; 29/822

(57) ABSTRACT

A method and a device for quickly feeding slats transversely into U-shaped troughs, simultaneously inserting multiple slats into ladder cords, staking the stringed slats, and spacing the assemblies of stringed slats for easy handling are disclosed. The device uses a slat dispatcher and sucking roller to place the slats into U-shaped troughs. Then the salts are transversely pushed into inter-rung openings of ladder cords at the same time. The slats stringed by the ladder cords as an assembly are collected upward and piled. The piled assemblies are spaced for easy handling.

### BACKGROUND OF THE INVENTION

1. Technical Field

The present invention relates to manufacturing of window blinds, and more particularly, to a method and a device for quickly feeding slats transversely into U-shaped troughs, simultaneously inserting multiple slats into ladder cords, staking the stringed slats, and spacing the assemblies of stringed slats for easy handling.

2. Description of Related Art

Suspensible horizontal window blinds have long been popular among consumers for their pleasing appearances and easy operation. The fact that such a device has not been completely replaced over so many years since its first introduction demonstrates its economical and practical values.

As known, a horizontal window blind is typically composed of slats that are stringed and hung by two to four ladder cords. By operating a rotating drum atop the ladder cords, the slats can be rotate to allow light to pass between the slats or to overlap and block light. A control cord vertically linking the slats is provided for a user to operate, thereby downward spreading or upward collecting the slats.

Throughout manufacturing process for such a horizontal window blind, it is the most labor-consuming procedure to insert numerous slats, one by one, into two to four ladder cords that hang the slats. To date, this procedure still mainly relies on manual operation. While a mach for assembling slats was designed many years ago, the machine still has to insert slats to ladder cords one by one, and its shortcomings include:

1. Numerous slats have to be successively arranged through complicated steps with low efficiency. For example, to make a window blind with 36 slats, the machine has to operate its shuttle 36 times.

2. For assembling slats of different numbers or different lengths, the machine has to reset jigs and operating programs, being inconvenient.

3. The machine is structurally complicated. In case of slat jamming or operation interruption, the troubleshooting is usually time-consuming, thus delaying manufacturing.

4. Each of this kind of machines requires an exclusive operator to operate and monitor, causing increased labor costs.

5. The stringed slat assembly is loose so it has to be removed from the machine manually and is unfavorable for subsequent processing.

In view that the traditional assembling processes are far from being satisfying to the modern times where accuracy, efficiency and profitability are required everywhere, the inventor of the present invention has taken long time in research and development before herein proposing an improved assembling machine and method for making window blinds. The disclosed method and device for transverse slat feeding, multi-slat stringing, stringed slat piling and slat assembly spacing for manufacturing of window blinds allow plural slats to be transversely inserted to ladder cords in a single operation, and allow slat assemblies stringed by ladder cords to be piled up for separate storage that facilitates subsequent processing.

### SUMMARY OF THE INVENTION

In order to improve the known technology for window blind assembling, the present invention uses a slat dispatcher to stack a plurality of slats in a slat cradle and a sucking roller next to the cradle to suck the slats on by one successively. The sucked slats are placed into vertically aligned U-shaped troughs, respectively.

The present invention further has a piling unit that includes piling supporters. When raised, the piling supporters positions ladder cords. After the slats are dispatched, a pushing board behind the U-shaped troughs horizontally pushes the slats from the U-shaped troughs to between rungs of the ladder cords. Then the piling supporters of the piling unit lift to prop up the slats stringed by the ladder cords, thereby forming piled assemblies of stringed slat.

Then, a spacing unit before the stringed and piled slats uses its spacing pins on its chains to separate the piled slat assemblies, so that a worker can easily handle the piled slat assembly with his/her single hand, thereby facilitating subsequent processing.

### BRIEF DESCRIPTION OF THE DRAWINGS

The invention as well as a preferred mode of use, further objectives and advantages thereof will be best understood by reference to the following detailed description of illustrative embodiments when read in conjunction with the accompanying drawings, wherein:

FIG. 1 is a perspective view of the present invention;

FIG. 2 is also a perspective view of the present invention, taken from a different viewpoint;

FIG. 3 is a perspective view of main components of a slat dispatching unit, a slat stringing unit and a piling unit the present invention;

FIG. 4 is a perspective view of a slat dispatcher of the slat dispatching unit of the present invention;

FIG. 5 is a side view of the slat dispatcher of the slat dispatching unit of the present invention;

FIG. 6 is a perspective view of main components of the slat dispatching unit and the piling unit of the present invention;

FIG. 7 illustrates slat inserting operation of the slat dispatching unit and slat stringing unit of the present invention;

FIG. 8 illustrates slat inserting operation of the slat dispatching unit and slat stringing unit of the present invention from a different viewpoint;

FIGS. 9 and 10 are perspective drawings illustrating slat piling operation of the piling unit of the present invention; and

FIG. 11 is a side drawing illustrating slat piling operation of the piling unit of the present invention.

### DETAILED DESCRIPTION OF THE INVENTION

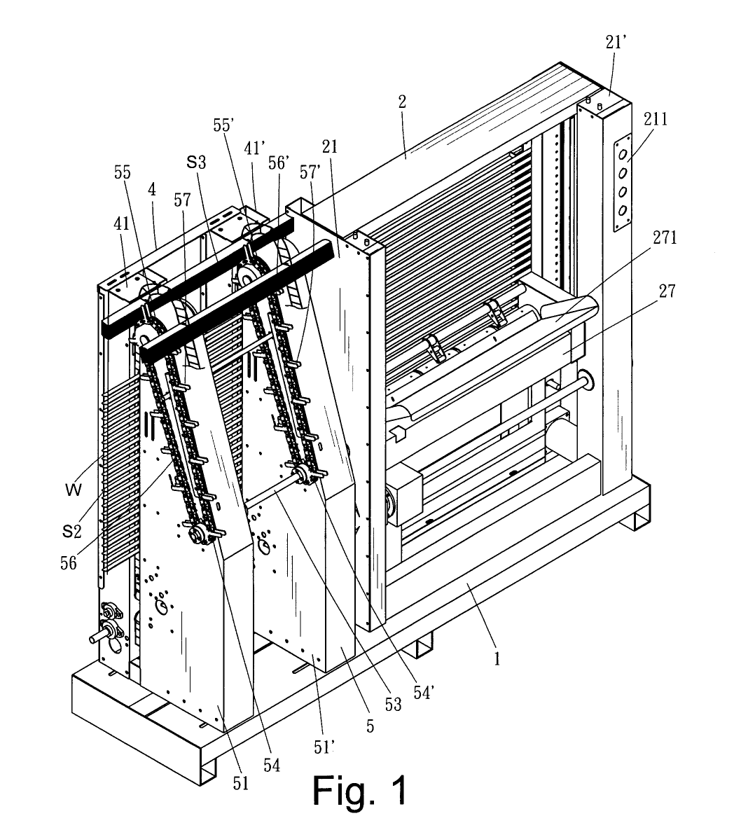

According to the present invention, a method and device for transverse slat feeding, multi-slat stringing, stringed slat piling and slat assembly spacing for manufacturing a window blind are herein described in conjunction with the accompanying drawings. Referring to FIG. 1, the device of the present invention has a machine base 1 on which a slat dispatching unit 2, a slat stringing unit 3, a piling unit 4 and a spacing unit 5 are provided.

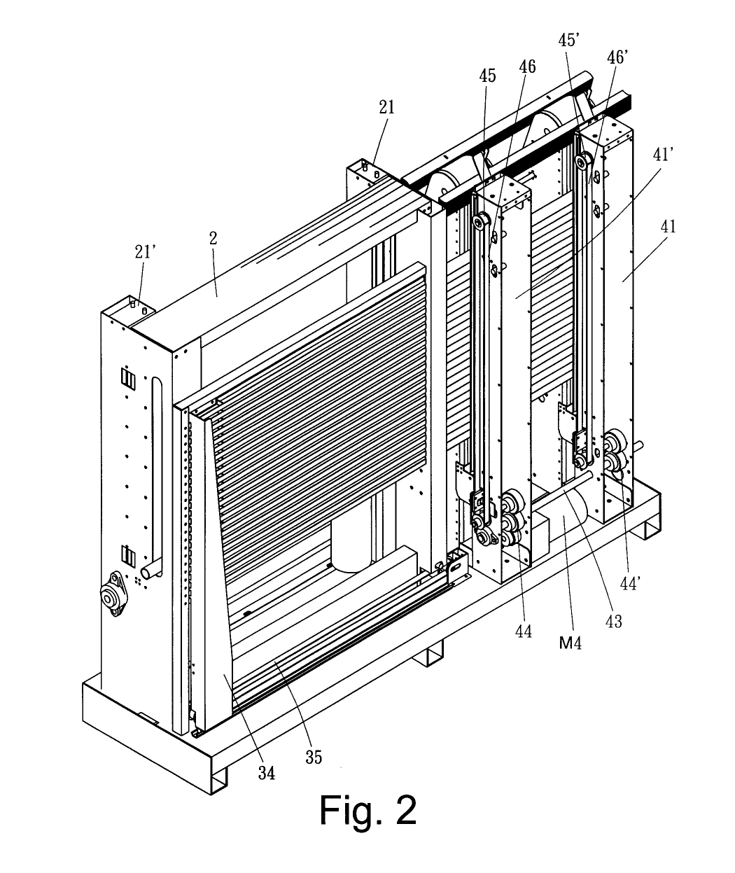

As shown in FIGS. 1 through 3, the slat dispatching unit 2 on the machine base 1 has a pair of symmetrical posts 21 and 21′. One of the posts is provided with a control panel 211. A rotatory shaft 23 is hung between the posts 21 and 21′ and driven by a servomotor M1. The rotatory shaft 23 has two ends equipped with rolling wheels 24 and 24′. The posts 21 and 21′ are atop installed with rolling wheels 25 and 25′. Belts 26 and 26′ are mounted around each pair of the vertically aligned rolling wheels 24, 24′ and 25, 25′.

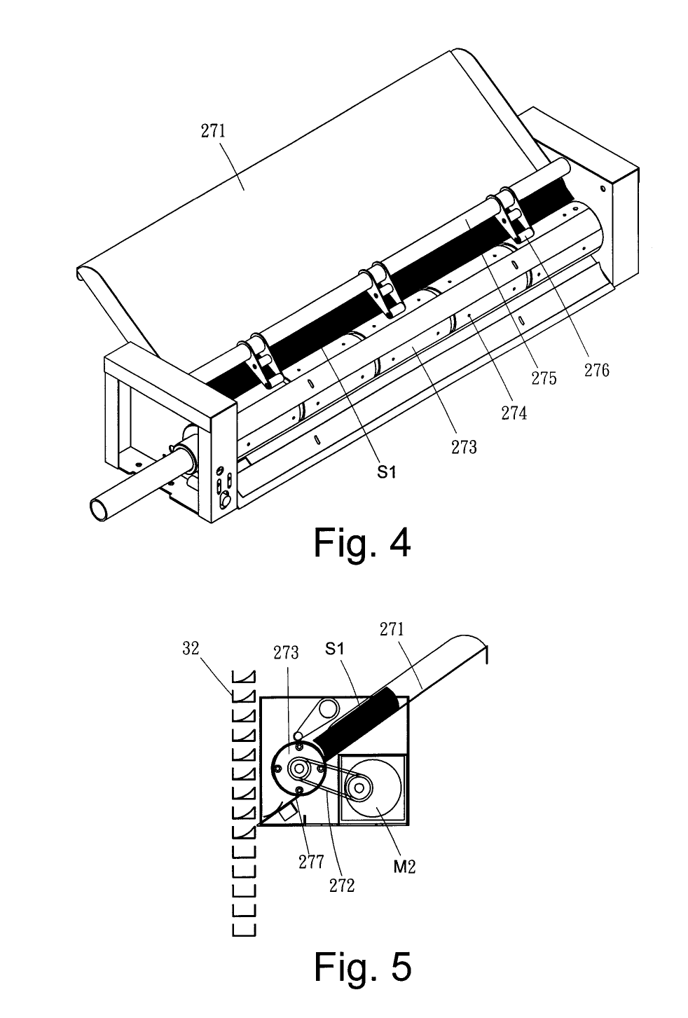

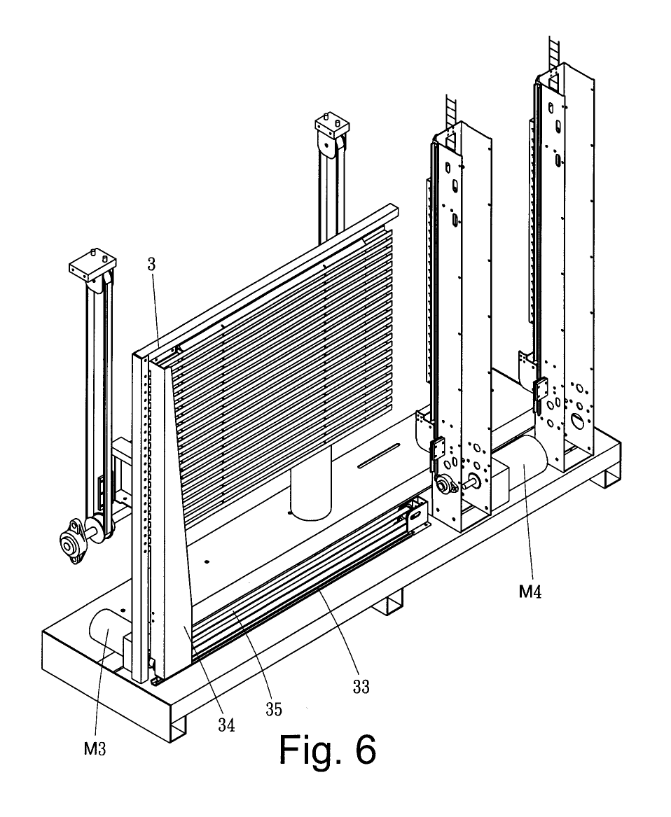

Referring to FIGS. 4 and 5, a slat dispatcher 27 is arranged between the belts 26 and 26′. The slat dispatcher 27 has a front edge equipped with a slat cradle 271 for receiving plural stacked slats S1 to be stringed, and has one side provided with a sucking roller 273 receiving air from an air compressor and driven by a servomotor M2 through a belt pulley 272. The sucking roller 273 is hollow and peripherally formed with equidistant sucking vents 274. The slat dispatcher 27 further has a transverse rod 275 close to the sucking roller 273. The transverse rod 275 comprises a plurality of evacuating pins 276. In addition, an evacuating finger 277 is deposited below the sucking roller 273.

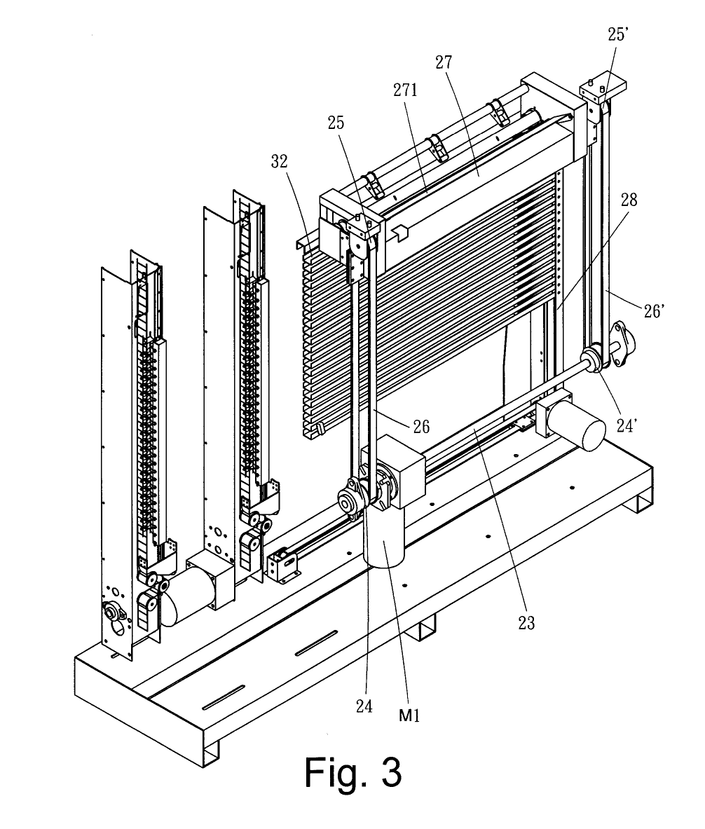

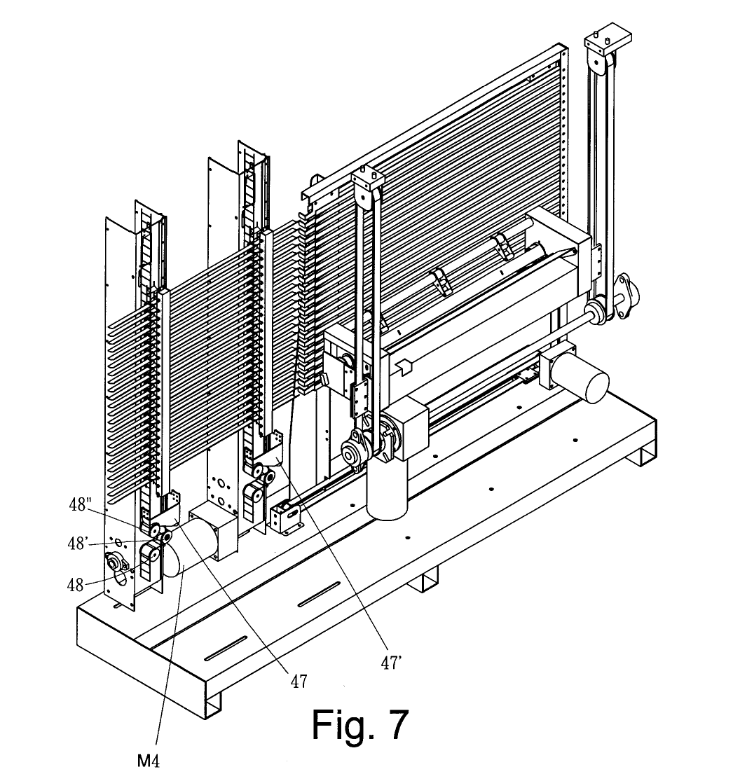

Referring to FIGS. 3 and 6, a slat stringing unit 3 is settled on the machine base 1 beside the sucking roller 273. The slat stringing unit 3 comprises a pillar 31 and a pushing board 34. The pillar 31 holds vertically aligned, equidistant U-shaped troughs 32.

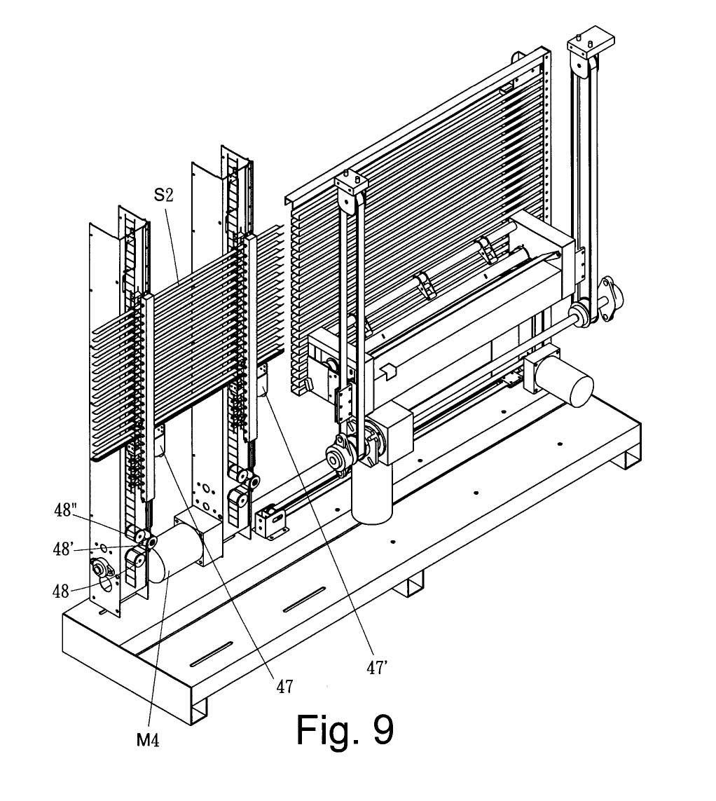

As shown in FIGS. 6 and 8, a sliding guide 33 is arranged on the machine base 1 corresponding to the U-shaped troughs 32. The pushing board 34 is installed in the sliding guide 33 to be driven by a servomotor M3 through a belt pulley 35. The pushing board 34 stretches into each said U-shaped trough 32.

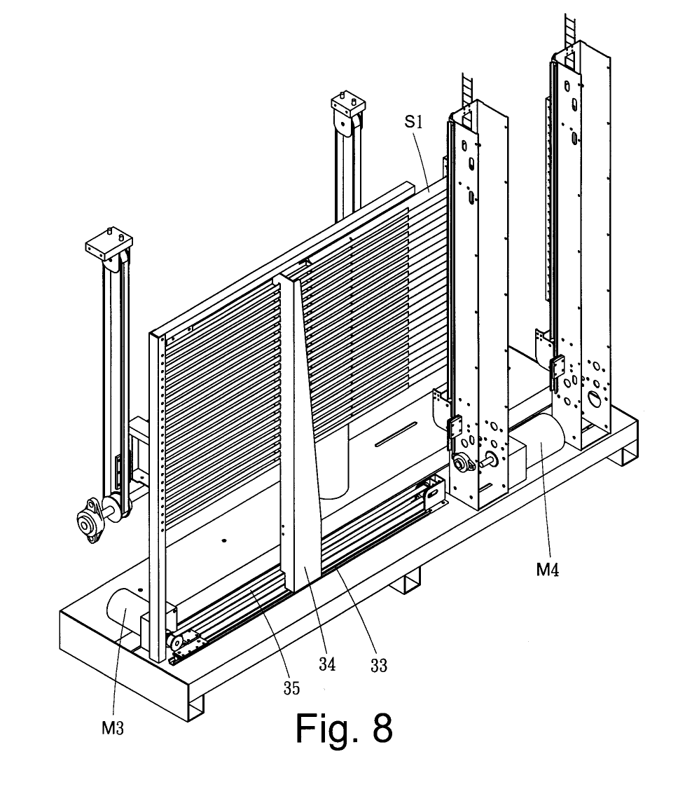

As can be seen in FIG. 7, a piling unit 4 is upright set on the machine base 1 corresponding to the U-shaped troughs 32. The piling unit comprises abreast frames 41 and 41′. The frames 41 and 41′ are linked by a rotatory shaft 43 that is driven by a servomotor M4. The rotatory shaft 43 has two ends equipped with rolling wheels 44 and 44′ while the frames 41 and 41′ are atop installed with rolling wheels 45 and 45′, respectively. Belts 46 and 46′ link the vertically aligned rolling wheels 44, 44′ and 45, 45′. Each of the belts 46, 46′ is affixed with a piling supporter 47 or 47′.

Before each of the frames 41 and 41′, there are ladder-cord rolling wheels 48, 48′ and 48″ coming as a set for guiding an introduced ladder cord W. At the beginning, a slat S1 to be assembled is inserted between rungs of the ladder cords W and then supported by spacing pins 57, 57′ of a spacing unit 5, which will be illustrated in detail below. Thereby, the ladder cords W are suspended upright such that each inter-rung opening of the ladder cords W is aligned accurately with one said U-shaped trough 32 and one pair of slat-guiding members 49, 49′.

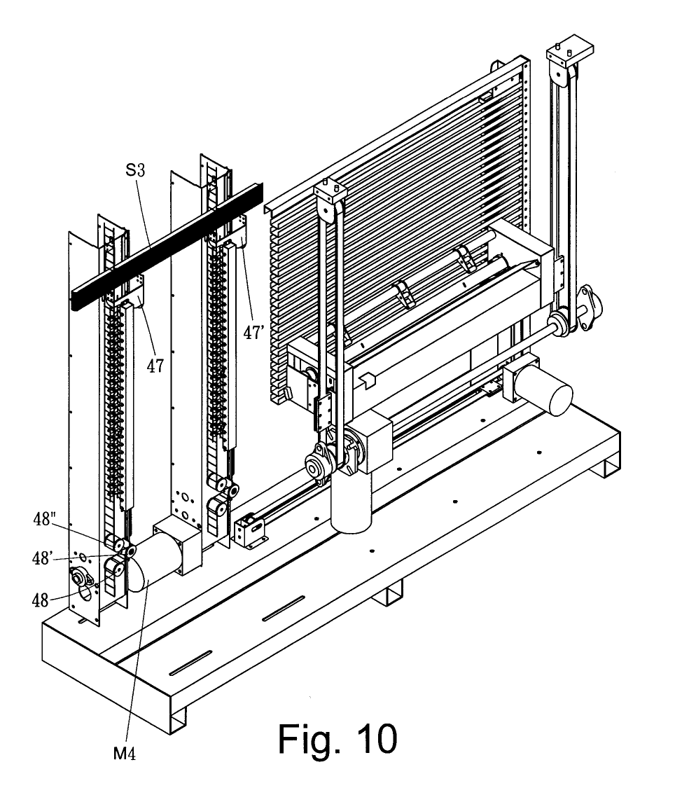

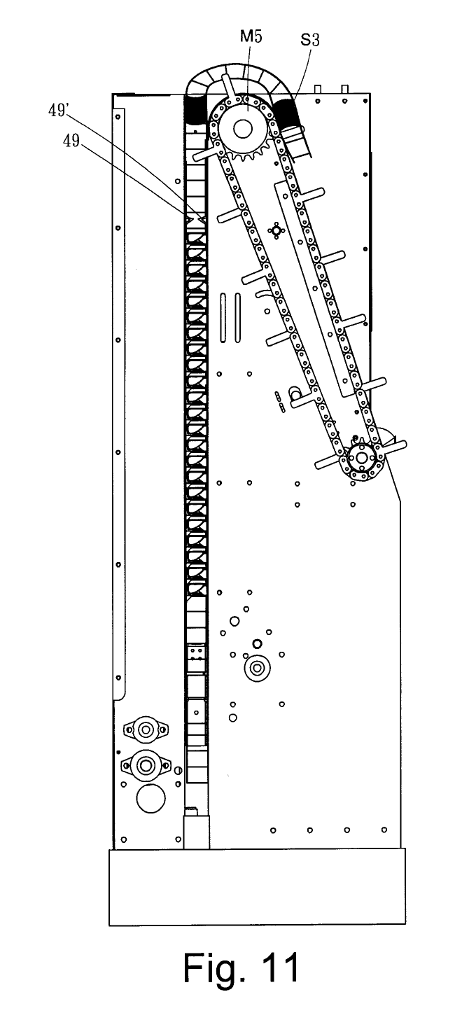

Referring to FIGS. 1, 9, 10 and 11, the spacing unit 5 is set on the machine base 1 in front of the piling unit 4. The spacing unit 5 has abreast slanting frames 51, 51′ quantitatively equal to the frames 41, 41′ of the piling unit 4. The slanting frames 51, 51′ support therebetween a rotatory shaft 53 driven by a servomotor M5. The rotatory shaft 53 has two ends equipped with gear wheels 54 and 54′ while the two slanting frames 51, 51′ are atop provided with gear wheels 55 and 55′, respectively. Chains 56 and 56′ link the vertically aligned gear wheels 54, 54′ and 55, 55′. The chains have equidistant spacing pins 57 and 57′. The two sets of gear wheels 54, 55 and 54′, 55′ are set slantwise so that their upper ends are close to the top of the piling unit 4.

Between the frames 41, 41′ of the piling unit 4 and the slanting frames 51, 51′of the spacing unit 5, there are equidistant slat-guiding members 49 and 49′ for guiding the slats into the ladder cords and supporting the inserted slats S2.

The servomotors M1, M2, M3, M4, M5 and the control panel 211 are electrically connected to a control circuit so that the control circuit uses its built-in programs and circuit to control the servomotors M1, M2, M3, M4 and M5 to start, to operate or to stop.

In operation, for initiating the assembling process, a slat S1 to be assembled is set in inter-rung openings of the ladder cords W and placed on the spacing pins 57 and 57′ of the spacing unit 5 so that the ladder cords W are hung upright with each of their inter-rung openings accurately aligned with one said U-shaped trough 32 and a set of the slat-guiding members 49 and 49′. Then, plural slats S1 to be assembled are stacked in the slat cradle 271 of the slat dispatcher 27.

By operating a switch on the control panel 211, the servomotor M1 of the slat dispatching unit 2 is driven to rotate the rotatory shaft 23 and in turn the belts 26 and 26′ so as to lift the slat dispatcher 27 to a standby position. Then the sucking roller 273 of the slat dispatcher 27 sucks air while rotated by the belt pulley 272 driven by the servomotor M2. As the sucking roller 273 rotates and takes in air, the bottommost one of the slats S1 stacked in the slat cradle 271 is attached to and move downward with the rolling sucking roller 273. In virtue of the evacuating pin 276, there is only one slat S1 sucked at one time. When the slat S1 is conveyed to a lower position, the evacuating finger 277 below the sucking roller 273 evacuates the slat S1 from the sucking vents 274 of the sucking roller 273, so that the slat S1 falls into the upmost one of the vertically aligned U-shaped troughs 32. The slat dispatcher 27 then lowers more each time according to the interval between the U-shaped troughs 32 ad repeats the foregoing operation, until each of the U-shaped troughs 32 receives a slat. Afterward, the slat dispatcher 27 lifts and returns to its standby position.

Subsequently, the servomotor M3 activates to drive the belt pulley 35, so that the pushing board 34 stretching into all the U-shaped troughs 32 makes all the slats S1 in the U-shaped troughs 32 move toward the piling unit 4, and makes each of the slats S1 accurately enter the corresponding inter-rung openings of the ladder cords W along the slat-guiding members 49 and 49′, thereby accomplishing one multi-slat stringing. After the slats S1 are inserted into the ladder cords W, the pushing board 34 returns to its standby position.

After the foregoing multi-slat stringing work, the servomotor M4 drives the rotatory shaft 43 and the belts 46, 46′of the piling unit 4, and makes the piling supporters 47 and 47′ receiving the bottommost stringed slat S2 move upward, so that all the slats stringed by the ladder cords W are collected upward to form a piled assembly of stringed slats S3. Afterward, the piling supporters 47 and 47′ return to their standby position.

At this time, the servomotor M5 of the spacing unit 5 in front of the piling unit 4 drives the slanting chains 56 and 56′ to move, and makes the spacing pins 57 and 57′ that are most closet to and now supporting the piled assembly of stringed slats S3 to move forward while the piling supporters 47 and 47′ of the piling unit 4 return to their standby position. Thereby, plural piled assemblies of stringed slats S3 are separated, so that a worker can easily cut the ladder cords W and handle one piled assembly of stringed slats S3 with his/her one hand. The piled assembly of stringed slats S3 facilitates handling and subsequent processing. The invention thus achieves transverse slat feeding, multi-slat stringing, stringed slat piling and slat assembly spacing in the manufacturing of window blinds.

What is claimed is:

1. A method for transverse slat feeding, multi-slat stringing, stringed slat piling and slat assembly spacing for manufacturing of a window blind, the method comprising using slat dispatcher 27 of a slat dispatching unit 2 on a machine base 1 to make a plurality of slats S1 that are stacked on a slat cradle 271 and are to be assembled to be sucked by a rotating sucking roller 273, the slats S1 then being evacuated by an evacuating finger 277 from sucking vents 274 of the sucking roller 273 and falling into one of a plurality of vertically aligned U-shaped troughs 32 provided on a slat stringing unit 3 next to the slat dispatching unit 2 until each of the U-shaped troughs 32 receives a slat, then a pushing board 34 stretching into the U-shaped troughs 32 making the slats S1 move from the U-shaped troughs 32 toward the piling unit 4, so that each of the slats S1 is accurately inserted into inter-rung openings of ladder cords W along slat-guiding members 49, 49′, thereby accomplishing one multi-slat stringing operation, piling supporters 47, 47′ of the piling unit 4 receiving a bottommost stringed slat S2 and moving upward, so that all the slats stringed by the ladder cords W are collected upward to form a piled assembly of stringed slats S3, and spacing pins 57, 57′ equidistantly provided on chains 56, 56′ of the spacing unit 5 in front of the piling unit 4 receiving the piled assembly of stringed slats S3 and moving forward, so that plural said piled assemblies of stringed slats S3 are separated, thereby achieving transverse slat feeding, multi-slat stringing, stringed slat piling and slat assembly spacing in the manufacturing of the window blinds.

2. The method of claim 1, wherein for initiating assembling, one said slat S1 to be assembled is set in inter-rung openings of the ladder cords W and placed on the spacing pins 57 and 57′ of the spacing unit 5 so that the ladder cords W are hung upright with each of their inter-rung openings accurately aligned with one said U-shaped trough 32 and a set of the slat-guiding members 49, 49′, and then plural said slats S1 to be assembled are stacked in the slat cradle 271 of the slat dispatcher 27.

3. A device for transverse slat feeding, multi-slat stringing, stringed slat piling and slat assembly spacing for manufacturing of a window blind, the device comprising a machine base 1, on which there are:
a slat dispatching unit 2 having a pair of symmetrical posts 21, 21′, one of the posts being provided with a control panel 211, a rotatory shaft 23 being hung between the posts 21, 21′ and driven by a servomotor Ml, the rotatory shaft 23 having two ends equipped with rolling wheels 24, 24′, the posts 21, 21′ being atop installed with rolling wheels 25, 25′, belts 26, 26′ being mounted around each pair of the vertically aligned rolling wheels 24, 24′, 25, 25′, a slat dispatcher 27 being arranged between the belts 26, 26′, the slat dispatcher 27 having a front edge equipped with a slat cradle 271 for receiving plural stacked slats S1 to be stringed, and having one side provided with a sucking roller 273 receiving air from an air compressor and driven by a servomotor M2 through a belt pulley 272, the sucking roller 273 being hollow and peripherally formed with equidistant sucking vents 274, the slat dispatcher 27 further having a transverse rod 275 close to the sucking roller 273, the transverse rod 275 comprising a plurality of evacuating pins 276, and an evacuating finger 277 being deposited below the sucking roller 273.
a slat stringing unit 3 being settled on the machine base 1 beside the sucking roller 273, the slat stringing unit 3 comprising a pillar 31 and a pushing board 34, the pillar 31 holding vertically aligned, equidistant U-shaped troughs 32, a sliding guide 33 being arranged on the machine base 1 corresponding to the U-shaped troughs 32, the pushing board 34 being installed in the sliding guide 33 to be driven by a servomotor M3 servomotor M3 through a belt pulley 35, the pushing board 34 stretching into each said U-shaped trough 32;
a piling unit 4 being upright set on the machine base 1 corresponding to the U-shaped troughs 32, the piling unit comprising abreast frames 41, 41′, the frames 41, 41′ being linked by a rotatory shaft 43 that is driven by a servomotor M4, the rotatory shaft 43 having two ends equipped with rolling wheels 44, 44′ while the frames 41, 41′ are atop installed with rolling wheels 45, 45′, respectively, belts 46, 46′ linking the vertically aligned rolling wheels 44, 44′, 45, 45′, each of the belts 46, 46′ being affixed with a piling supporter 47 or 47′, before each of the frames 41, 41′, there being ladder-cord rolling wheels 48, 48′, 48″ coming as a set for guiding an introduced ladder cord W, for initiating assembling, a said slat S1 to be assembled being inserted into inter-rung opening of the ladder cords W and then supported by spacing pins 57, 57′ of a spacing unit 5, thereby, the ladder cords W being suspended upright such that each said inter-rung opening of the ladder cords W is aligned accurately with one said U-shaped trough 32 and one pair of slat-guiding members 49, 49′;
a spacing unit 5 being set on the machine base 1 in front of the piling unit 4, the spacing unit 5 having abreast slanting frames 51, 51′ quantitatively equal to the frames 41, 41′ of the piling unit 4, the slanting frames 51, 51′ supporting therebetween a rotatory shaft 53 driven by a servomotor M5, the rotatory shaft 53 having two ends equipped with gear wheels 54, 54′ while the slanting frames 51, 51′ are atop provided with gear wheels 55, 55′, respectively, chains 56, 56′ linking the vertically aligned gear wheels 54, 54′, 55, 55′, the chains having equidistant spacing pins 57, 57′, the two sets of gear wheels 54, 55, 54′, 55′ being set slantwise so that upper ends thereof are close to a top of the piling unit 4.

4. The device of claim 3, wherein between the frames 41, 41′ of the piling unit 4 and the slanting frames 51, 51′of the spacing unit 5, there are equidistant slat-guiding members 49, 49′ for guiding the slats into the inter-rung openings of the ladder cords and supporting inserted slats S2.

5. The device of claim 3, wherein the servomotors M1, M2, M3, M4, M5 and the control panel 211 are electrically connected to a control circuit so that the control circuit uses its built-in programs and circuit to control the servomotors M1, M2, M3, M4 and M5 to start, to operate or to stop.

6. The device of claim 3, wherein the slat dispatcher 27 is at a standby position thereof when starting to dispatch the slats and lifts and returns to the standby position after the slats are dispatched.

7. The device of claim 3, wherein the pushing board 34 stretching into all the U-shaped troughs 32 returns to a standby position thereof after each of the slats S1 accurately enters the corresponding inter-rung openings of the ladder cords W along the slat-guiding members 49, 49′.

8. The device of claim 3, wherein the piling supporters 47, 47′ of the piling unit 4 return to a lower standby position thereof after all the slats S2 stringed by the ladder cords W are collected upward to form a piled assembly of stringed slats S3.
